(19) United States
(12) Patent Application Publication
(10) Pub. No.: US 2021/0208375 A1
(43) Pub. Date: Jul. 8, 2021

(54) OPTICAL ORTHORECTIFICATION SYSTEM

(71) Applicant: Raytheon Company, Waltham, MA (US)

(72) Inventors: Timothy Johnson, El Segundo, CA (US); Lacy G. Cook, El Segundo, CA (US)

(73) Assignee: Raytheon Company, Waltham, MA (US)

(21) Appl. No.: 17/015,502

(22) Filed: Sep. 9, 2020

Related U.S. Application Data
(60) Provisional application No. 62/956,434, filed on Jan. 2, 2020.

(51) Int. Cl. G02B 17/06; G02B 13/06

(52) U.S. Cl. CPC G02B 17/0663; G02B 13/06

(57) ABSTRACT

An example optical system includes freeform mirrors configured to receive light from an object and to reflect the light among the freeform mirrors to produce an optical image of the object having positive distortion. The freeform mirrors include non-rotationally symmetric mirrors. The optical system also includes an along-track scanner having a line of imaging sensors configured to receive the optical image of the object from the freeform mirrors and to produce an image of the object having the positive distortion.

### CROSS-REFERENCE TO RELATED APPLICATION

This application claims the benefit of, and priority to, U.S. Provisional Patent Application No. 62/956,434, which was filed Jan. 2, 2020, and which is titled “Optical Design Using Image Distortion for Orthrorectification”. The contents of U.S. Provisional Patent Application No. 62/956,434 are incorporated herein by reference.

### TECHNICAL FIELD

This specification describes example optical orthorectification systems.

### BACKGROUND

Orthorectification includes processes for performing corrections to an image of an object to account for the object's topology, camera distortion, and/or the tilt angle between the camera and the object. For example, imaging the Earth from above, from either an aircraft or a satellite, can result in image distortion. This is not due to optical effects inside the imaging sensor used to perform the imaging, but instead is due to the curvature or tilt of the Earth's surface relative to the sensor. Orthorectification may be performed using image processing techniques to correct this distortion but this reduces the image's spatial resolution.

### SUMMARY

Described herein are example optical systems for optically introducing positive distortion into an image to counteract negative distortion of the image caused by the curvature of an object, such as the curvature of the Earth's surface.

An example optical system includes freeform mirrors configured to receive light from an object and to reflect the light among the freeform mirrors to produce an optical image of the object having positive distortion. The freeform mirrors includes non-rotationally symmetric mirrors. The optical system includes an along-track scanner having a line of imaging sensors configured to receive the optical image of the object from the freeform mirrors to produce an image of the object having the positive distortion. The optical system may include one or more of the following features, either alone or in combination.

The freeform mirrors may each be defined by a Zernike polynomial. The Zernike polynomial includes Zernike coefficients that are based on the positive distortion and image quality to be produced by the freeform mirrors. The optical system may be all-reflective and may have a wide field-of-view. The freeform mirrors may be off-axis and may not include a central obscuration. The freeform mirrors may each be defined by a Zernike polynomial having 23 or more terms. Each term may be associated with a Zernike coefficient. The object may be a spheroid and the positive distortion may counteract negative distortion resulting from a shape of the spheroid.

The freeform mirrors may include a first freeform mirror to receive light from the object and to reflect the light to produce first reflected light, a second freeform mirror to receive and to reflect the first reflected light to produce second reflected light, a third freeform mirror to receive and to reflect the second reflected light to produce third reflected light, and a fourth freeform mirror to receive and to reflect the third reflected light to produce the optical image. The first freeform mirror may include a negative optical-power surface; the second freeform mirror may include a zero optical-power surface; the third freeform mirror may include a negative optical-power surface; and the fourth freeform mirror may include a positive optical-power surface. An aperture stop may be located between the fourth freeform mirror and the along-track scanner. The aperture stop may function as an exit pupil for reflections of the third reflected light produced by the fourth freeform mirror.

The optical system may have a field-of-view of 70° or more, and the freeform mirrors may be designed to reduce image aberrations at the field-of-view. The image aberrations may include positive image distortion. The object may be the Earth and the positive distortion to be produced by the freeform mirrors may be based, at least in part, on an altitude of the along-track scanner relative to the Earth, a radius of the Earth, and a field angle of an imaging sensor in the along-track scanner.

An example method includes determining an amount of positive distortion to be produced by freeform mirrors based on a position of the freeform mirrors relative to an object, where the freeform mirrors include non-rotationally symmetric mirrors; configuring the freeform mirrors based on the amount of positive distortion; receiving light from the object at the freeform mirrors; reflecting the light among the freeform mirrors to produce an optical image of the object having the positive distortion; and receiving the optical image of object from the freeform mirrors at an along-track scanner that includes imaging sensors. The imaging sensors obtain an image of the object having the positive distortion based on the optical image. The method may include one or more of the following features, either alone or in combination.

The freeform mirrors may each be defined by a Zernike polynomial that is based on the positive distortion. The Zernike polynomial may include Zernike coefficients that are based on the positive distortion. The freeform mirrors may each be defined by a Zernike polynomial that is based on the positive distortion. The Zernike polynomial may have 23 or more terms, with each term being associated with a Zernike coefficient.

The object may be a spheroid and the positive distortion may counteract negative distortion resulting from a shape of the spheroid. The receiving and reflecting operations may include the following: a first freeform mirror receiving light from the object and reflecting the light to produce first reflected light; a second freeform mirror receiving and reflecting the first reflected light to produce second reflected light; a third freeform mirror receiving and reflecting the second reflected light to produce third reflected light; and a fourth freeform mirror receiving and reflecting the third reflected light to produce the optical image. The first freeform mirror may include a negative optical-power surface; the second freeform mirror may include a zero optical-power surface; the third freeform mirror may include a negative optical-power surface; and the fourth freeform mirror may include a positive optical-power surface.

The method may include passing the third reflected light through an aperture stop between the fourth freeform mirror and the along-track scanner to produce the optical image. An optical system comprised of the along-track scanner and the freeform mirrors may have a field-of-view of 70° or more, and the freeform mirrors may be designed to reduce image aberrations at the field-of-view. The image aberrations may include image distortion. The object may be the Earth and the positive distortion may be determined based, at least in part, on an altitude of the along-track scanner relative to the Earth, a radius of the Earth, and a field angle of an imaging sensor in the along-track scanner.

Any two or more of the features described in this specification, including in this summary section, may be combined to form implementations not specifically described in this specification.

At least part of the optical systems and processes described in this specification may be configured, designed, and/or controlled by executing, on one or more processing devices, instructions that are stored on one or more non-transitory machine-readable storage media. Examples of non-transitory machine-readable storage media include read-only memory, an optical disk drive, memory disk drive, and random access memory. At least part of the optical systems and processes described in this specification may be configured, designed, and/or controlled using a computing system comprised of one or more processing devices and memory storing instructions that are executable by the one or more processing devices to perform various control operations.

The details of one or more implementations are set forth in the accompanying drawings and the following description. Other features and advantages will be apparent from the description and drawings, and from the claims.

### DESCRIPTION OF THE DRAWINGS

FIG. 1 is a side-view block diagram showing an example distortion ray and wavefront error.

FIG. 2 is a block diagram showing negative distortion produced when imaging the surface of the Earth using an along-track imaging system.

FIG. 3 is a block diagram of a satellite in polar/low-Earth orbit.

FIG. 4 is a block diagram of a satellite in geostationary orbit around the Earth.

FIG. 5 is a block diagram showing example operation of an along-track imaging system and of a cross-track imaging system.

FIG. 6 is a block diagram showing a satellite in orbit relative to the Earth.

FIG. 7 is graph showing example ideal distortions for a constant ground sampling distance (GSD) for both a polar orbit and a geostationary orbit.

FIG. 8 includes top-view block diagrams of an example all-reflective optical system for optically introducing positive distortion into an image, with (A) showing light rays reflected among mirrors and (B) showing a simplified version of those light rays from a single field point.

FIG. 9 includes side-view block diagrams of the example all-reflective optical system of FIG. 8 for optically introducing positive distortion into an image, with (A) showing light rays reflected among mirrors and (B) showing a simplified version of those light rays from a single field point.

FIG. 10 is a graph showing example distortion produced by the optical system of FIGS. 8 and 9 in polar orbit versus ideal distortion to obtain a constant GSD.

Like reference numerals in different figures indicate like elements.

### DETAILED DESCRIPTION

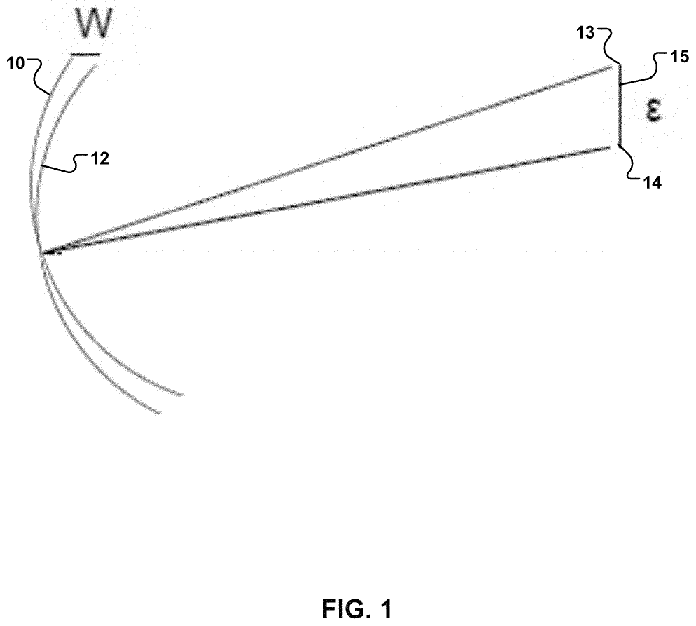

Distortion is an aberration that causes image warping without blurring. In a distorted image of an object, points in the image do not map to points in the object using magnification. Distortion is a wavefront error and an associated ray error at the image. Example distortion is shown in FIG. 1. As shown in FIG. 1, a wavefront (W) 10 is spherical but is tilted relative to an ideal reference sphere 12. This tilted wavefront focuses to a different point 13 than does reference sphere 12, which focuses to point 14. This difference in focus points is ray error c 15, which is a measure of the distortion.

Imaging the surface of the Earth (an oblate spheroid) from above typically results in a distorted image having reduced spatial resolution near edges of an imaging system's field of view (FOV). The effect is proportional to the FOV and the altitude of the imaging system. The effect is similar to the negative (e.g., barrel) distortion common in fish-eye lenses, but is due here to the convex shape of the Earth's surface and not to the optical system. Although image processing methods exist to partially correct for negative distortion, the reduced spatial resolution near the edge of field is typically unrecoverable using such methods. More specifically, when there is significant distortion, the image can be rectified for aesthetics and to measure distances, but the loss in spatial resolution due to ground sampling distance (GSD) growth cannot be recovered. In this regard, GSD refers to a distance between two consecutive pixel centers located on the ground. The GSD may increase correspondingly with an increase in the FOV. As GSD increases, the spatial resolution of the image and the amount of visible details in the image decreases. Performing an orthorectification process optically as the image is formed can, in some cases, preserve this spatial resolution more than image processing methods.

Ideally, to produce an image having less or no distortion, the object should be flat and oriented normal or perpendicular to a line of sight (LOS) of an image sensor. An example image sensor may be part of a camera and include or be part of a sensor array. Example types of image sensors include, but are not limited to, charge-coupled devices (CCD) and active-pixel sensors (CMOS sensors).

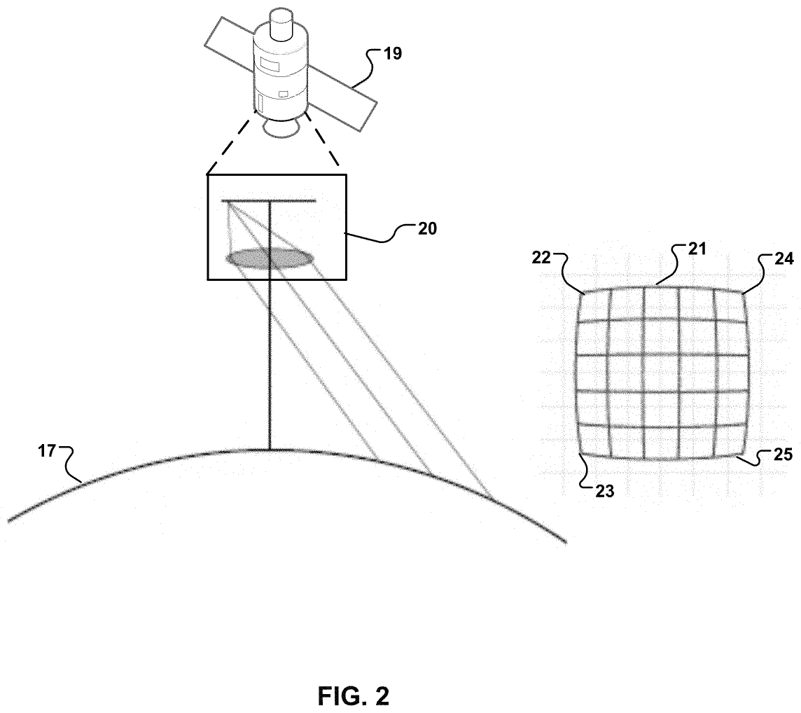

In contrast to the ideal situation described above, FIG. 2 illustrates the distortion caused by the curvature in the surface of the Earth 17 in relation to an example satellite 19 having an imaging system 20 for capturing images of the Earth's surface. For a perfect optical system having no internal distortion, the convex shape of the Earth's surface creates negative (e.g., barrel) image distortion 21 in the resulting images. That is, if the Earth's surface included a grid of lines, the grid would appear denser as the FOV increases, e.g., at points 22 to 25. This effect can be attributed to the increasing projection of GSD as FOV increases. To counteract at least some of this negative distortion, the optical systems described herein are designed and configured to produce positive distortion that is at least partly opposite to the negative distortion produced by the curvature of the Earth. In some implementations, the optical systems described herein are designed and configured to produce signify ant positive distortion that is equal to and opposite to the negative distortion produced by the curvature of the Earth.

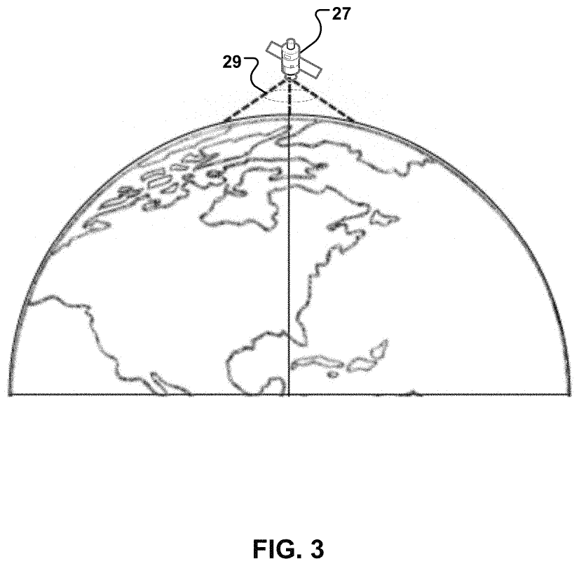

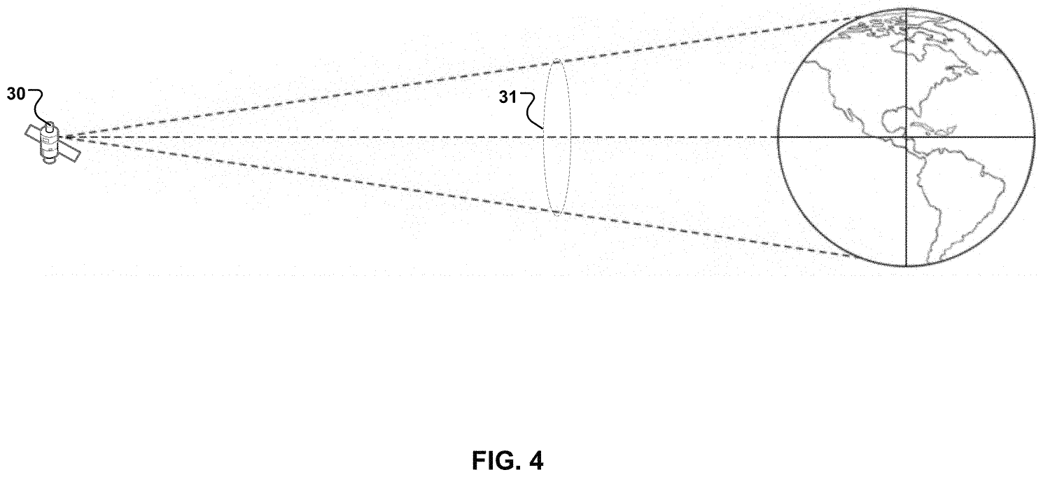

FIG. 3 shows a satellite 27 in an example polar/low-Earth orbit having a 110° full FOV 29 and FIG. 4 shows a satellite 30 in an example Earth geostationary orbit having a 34° full FOV 31. The example polar orbit is 830 kilometers (km) in altitude and has a ±55° FOV. The example geostationary orbit is 35,000 km in altitude and has a ±17° FOV. A satellite having the optical system described herein configured to image a surface of the Earth may be in either one of these orbits or in any other appropriate orbit.

In the polar orbit example of FIG. 3, satellite 27 rotates around the earth capturing images at a predefined coverage rate. In some implementations, the satellite's image sensors may generate images by scanning a one-dimensional (1D) array along the surface to create a two-dimensional (2D) image. The scanning motion of the image sensors may be dependent on the velocity of the satellite. There are two primary types of satellite image sensors, which are defined in terms of how they scan: along-track (or “push-broom”) sensors and across-track (or “whisk-broom”) sensors.

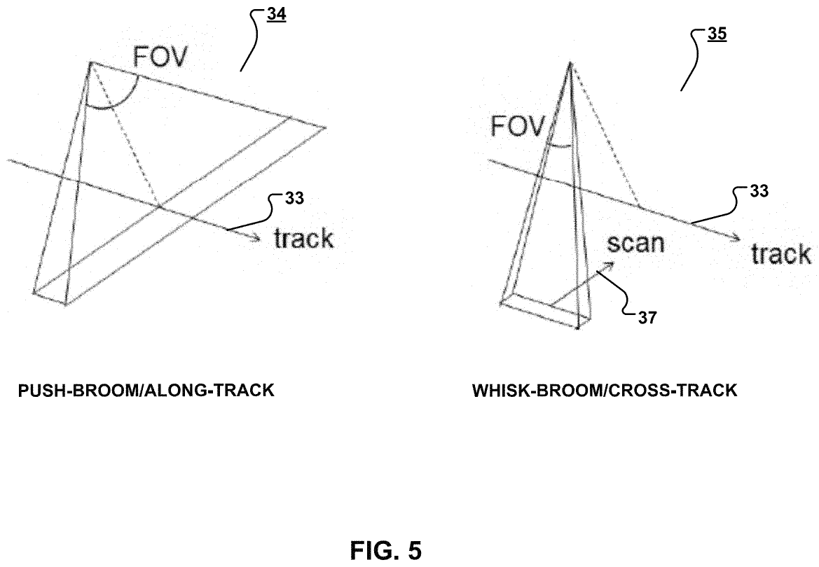

FIG. 5 shows these two types of scanning performed by the image sensors, in which “track” 33 in FIG. 5 is the satellite velocity vector. In along-track system 34, the scanning motion is in the same direction as track 33 and is obtained simply by the satellite moving over the Earth. The along-track system may have no moving parts but may employ a relatively wide FOV, examples of which include, but are not limited to, 50° or greater, 60° or greater, 70° or greater, 80° or greater, 90° or greater, 100° or greater, 110° or greater, or 120° or greater. On the other hand, in across-track system 35, the scanning motion 37 is perpendicular to the satellite velocity vector (track 33). Accordingly, an across-track system may require a separate scanning mechanism, either a single flat mirror in front of a telescope, or the telescope itself. Instead of rotating the entire sensor including a focal plane array (FPAA) and electronics, typically only the telescope or fore-optics rotates, while aft-optics are stationary and some type of derotation or beam stabilization optics are used in between.

As described above, a single 1D column of pixels can be used in an along-track imaging system to capture a 2D image of the Earth's surface. This column of pixels captures different parts of the Earth's surface at different times as the Earth's surface is scanned. Although a 1D column of pixels may be all that is needed to form a 2D image in imaging system, a 2D pixel array can be used with time delay integration (TDI) to increase signal-to-noise ratio (SNR) and dynamic range. Alternatively a 2D array can be used in a scanning system to provide hyperspectral or multi-spectral images.

In an across-track imaging system, for a flat scene, distortion in the cross-track axis 37 should be constant with the FOV in the track axis 33. If instead the distortion varies radially from the FOV center, then the cross-track field points would not overlap along a TDI row, resulting in misregistration or blurring. A similar error occurs if the time delay or scan rate is not correct, which is known as band-to-band misregistration in multispectral systems. The distortion profile required to avoid TDI pixel misregistration errors occurs in the distortion type known as anamorphism. This type of distortion is possible in bilaterally symmetric optical systems. So, a conventional axially-symmetric optical system does not produce the distortion field necessary to counter the distortion produced by the curvature of the Earth while avoiding TDI pixel misregistration. Keystone distortion (a tilt error in one axis of the image) along track axis 33 in along-track systems and scan axis 37 in across-track systems also produces this TDI error.

The optical systems described herein use freeform mirrors, which are non-rotationally or non-axially symmetric and which, therefore, may address the preceding types of distortion optically. The optical systems described herein may be particularly applicable to along-track (push-broom) imaging systems. This is because, in an along-track system, the required distortion to be added relative to the FOV is constant for a given orbit of a satellite. On the other hand, in an across-track (whisk broom) system, the satellite sensor's LOS is scanned or swept, so the relative tilt of the Earth's surface and the resulting keystone distortion changes with the FOV. To counteract the keystone distortion in an across-track system, an optical system may change the internal distortion inside the optical system. This may be done for an across-track system by incorporating a tilting mechanism on the FPA. The examples described herein, however, focus on an along-track (push-broom) system.

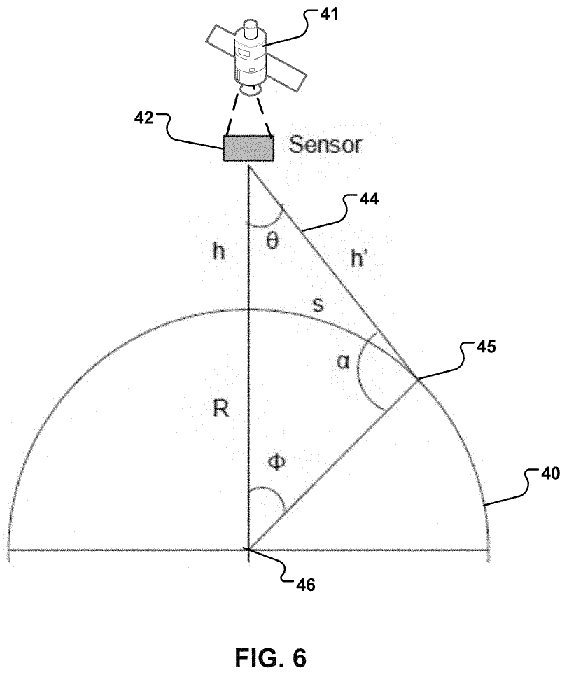

Example along-track (push-broom) imaging systems can be designed and configured to counteract negative (e.g., barrel) distortion in images of the Earth caused by the curvature in the Earth's surface. This is done by introducing positive distortion optically to counteract the negative distortion resulting from the curvature in the Earth's surface. In this regard, for a given image sensor/satellite altitude, the GSD, the instantaneous field-of-view (IFOV), and the FOV angle can be calculated using the geometry shown in FIG. 6. In FIG. 6 “h” is the altitude normal to the surface of Earth 40 of a satellite 41 containing sensor 42 in orbit around the Earth. Sensor 42 is part of an optical system to obtain images of the Earth. “R” is the radius of Earth 40 and “8” is the field angle of sensor 42 on the satellite. In this example, the field angle is the angle between the normal (h) and the LOS (h′) to a point 45 on an the object being imaged. Using the example of FIG. 6, the techniques described herein determine an amount of distortion to add to an image and then the design and configuration of an optical system containing freeform mirrors to achieve that amount of distortion.

As noted, an example of a freeform mirror is a non-rotationally symmetric or non-axially symmetric mirror. A freeform mirror used in the optical systems described herein includes a reflective surface having a shape that is defined by a Zernike polynomial. The shape may be irregular and, as indicated, asymmetric. The Zernike polynomial includes Zernike coefficients that are selected to model the positive distortion to be produced by the freeform mirrors. The Zernike polynomial includes Zernike coefficients that may be based on desired amounts of positive distortion and also image quality—for example, low levels of image blurring and/or a reduction in the amount or number of aberrations—to be produced by the freeform mirrors. In the example optical systems described herein, the Zernike polynomial may have 23 or more terms. For example, the Zernike polynomial may be a 23^{rd} or 26^{th} order polynomial, with each of its terms subjected to a Zernike coefficient. In other implementations, the freeform mirrors may be defined differently, for example, using different numbers of Zernike coefficients.

As noted, the negative (e.g., barrel) distortion produced by the curvature of the Earth may be corrected optically by introducing a corresponding amount of positive distortion into the design of an optical system for imaging the Earth's surface. The amount of positive distortion required to counteract the negative distortion resulting from the curved surface of the Earth may be calculated as a function of imaging sensor/satellite FOV and altitude. Referring to FIG. 6, equations are determined that relate the arc length (s) of the Earth's surface to the image sensor field angle (θ). These equations can then be used to obtain the changing GSD with field for a given pixel size. We start by using the law of sines to generate the following equation for (α)—the angle between the sensor and the center of the Earth—as viewed from a point on the Earth.

$$α = π - a sin [ ( \frac{R + h}{R} ) sin ( θ ) ]$$

Then, setting the sum of the angles (α, φ. θ) of triangle 44 to π allows us to solve for φ, which the angle between the normal to sensor 42 and a point 45 on the Earth 40 as viewed from the center 46 of the Earth.

$$\begin{matrix}ϕ = π - α - θ \\ = - θ + a sin [ ( \frac{R + h}{R} ) sin ( θ ) ]\end{matrix}$$

The arc length s can be written as follows.

$$s = R ϕ \\ = R [ - θ + a sin [ ( \frac{R + h}{R} ) sin ( θ ) ] ]$$

Taking the derivative of the arc length with respect to θ yields the following.

$$\frac{ds}{d θ} = R [ \frac{( h + R ) cos ( θ )}{R \sqrt{1 - \frac{{( h + R )}^{2} {sin}^{2} ( θ )}{{R}^{2}}}} - 1 ]$$

Finally, GSD can be written in terms of the derivative above and IFOV as follows.

$$GSD = ( \frac{ds}{d θ} ) IFOV$$

IFOV can vary due to internal distortion of the optical system. If the system has a constant focal length (f) with f=x/tan(θ) (where x is a light ray coordinate on a focal plane array), then IFOV increases with cos²(θ). An imaging sensor having a constant focal length under this definition and having an on-axis IFOV₀ has a GSD that further decreases with FOV according to the following equation.

$$GSD = ( \frac{ds}{d θ} ) {IFOV}_{0} {cos}^{2} ( θ )$$

If the imaging sensor has a constant focal length defined as f=dx/de indicating zero distortion and has a constant IFOV, we would drop the cos²(θ) factor from the preceding equation. We can then calculate the ideal percentage (%) of positive distortion (D_{ideal}) to be introduced by an optical system to counteract the negative distortion. The counteracting positive distortion is calculated as the ratio of GSD at nadir (GSD₀) to that of the GSD versus field of view. For example, if the GSD on the curved surface of the Earth is twice as large as it would be on a flat surface, this would ideally require an optical system having +100% distortion at a given field angle. This ideal distortion (D_{ideal}) is expressed as follows.

$${D}_{Ideal} = \frac{GSD ( θ ) - {GSD}_{0}}{{GSD}_{0}}$$

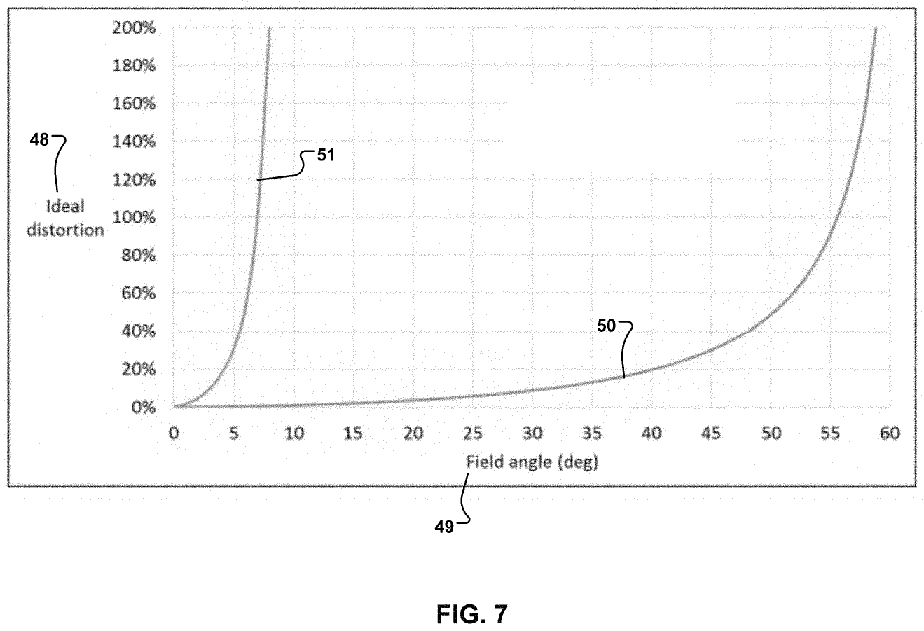

FIG. 7 shows examples of amounts of ideal positive image distortion 48 (in percentage) to counteract negative distortion resulting from curvature in the Earth's surface plotted in relation to field of view angle 49 (in degrees) for both an example polar orbit 50 and an example geostationary orbit 51 of a satellite over the Earth. As evident from FIG. 7, the ideal distortion grows asymptotically when the angle of the LOS approaches the tangent of the Earth's surface. The ideal distortion grows faster for a sensor in the geostationary orbit because there the FOV of the Earth is only about 16° in diameter. By contrast, from the perspective of the polar orbit, the FOV of the Earth is over 120° in diameter. The graph of FIG. 7 thus indicates that a sensor in polar orbit having a full field of view of 60° (that is, a maximum field angle of 30°) should have an ideal distortion of +7% to counter the negative distortion resulting from the Earth's surface. This number increases rapidly with FOV as a sensor with a full 110° FOV (that is, a maximum field angle of 55°) has an ideal distortion of +80%.

The example ideal distortion values of FIG. 7 are based on a sensor focal length (f) definition of f=x/tan(θ). If instead we use a sensor focal length (f) definition of f=dx/de, which indicates that zero distortion has constant IFOV, then the ideal distortion relative to field angle may be increased relative to that shown in FIG. 7.

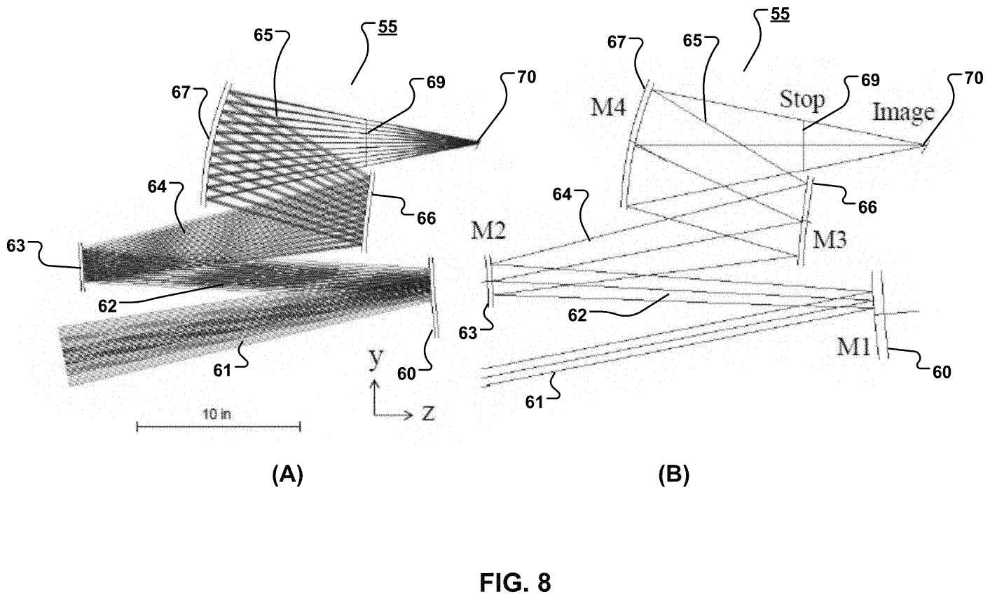

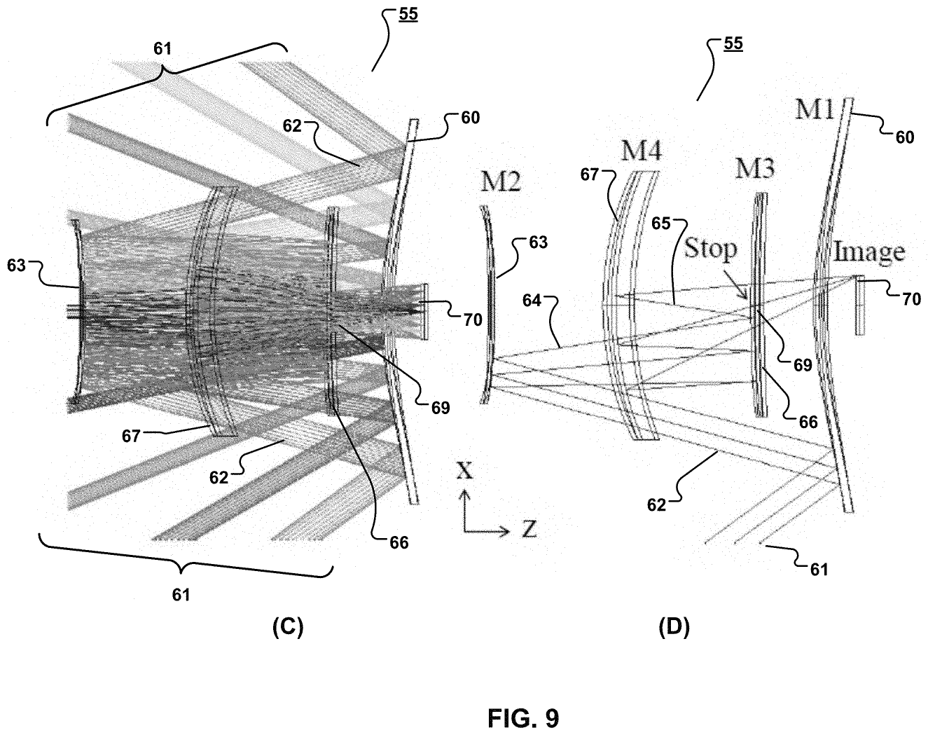

FIGS. 8 and 9 show views of the same example all-reflective optical system 55 for optically introducing positive distortion into an image to counteract the negative distortion caused by the curvature of an object, such as the curvature of the Earth's surface. FIG. 8 shows top views (A) and (B) of optical system 55 and FIG. 9 shows side views (C) and (D) of optical system 55. The (B) views of FIGS. 8 and 9 show simplified light rays. Optical system 55 includes a first (or primary, M1) freeform mirror 60 to receive light 61 from an object such as the surface of the Earth and to reflect the light 61 to produce first reflected light 62. A second (or secondary, M2) freeform mirror 63 receives and reflects the first reflected light 62 to produce second reflected light 64. A third (or tertiary, M3) freeform mirror 66 receives and reflects the second reflected light 64 to produce third reflected light 65. A fourth (or quaternary, M4) freeform mirror 67 receives and reflects the third reflected light 65 towards an aperture stop 69 to produce an optical image 70 on an image plane such as a sensor of an along-track scanner.

The aperture stop 69 between the fourth freeform mirror 67 and the along-track scanner image plane is configured to function as an exit pupil for reflections of the third reflected light 65 produced by the fourth freeform mirror 67. In some implementations, the first freeform mirror 60 includes a reflective surface that is at least partly or wholly a negative optical power surface; the second freeform mirror 63 includes a reflective surface that is at least partly or wholly a zero or low optical power surface; the third freeform mirror 66 includes a reflective surface that is at least partly or wholly a negative optical power surface; and the fourth freeform mirror 67 includes a reflective surface that is at least partly or wholly a positive optical power surface. Optical power is the degree to which a mirror converges or diverges reflected light. Mirrors that diverge light have negative optical power and mirrors that converge light have positive optical power.

There may be benefits to an all-reflective optical system over traditional refractive systems. Since the all-reflective (e.g., all-mirror) optical system 55 of FIGS. 8 and 9 is off-axis, a central obscuration found in reflective telescopes may be eliminated, allowing for superior performance in terms of image quality and throughput, including in the infrared region of the electromagnetic spectrum. In this regard, the example optical systems described herein are off-axis in that there is no central obscuration. A central obscuration can cause reductions in the optical energy in a central spot of the aperture. An on-axis system, such as one included in a Cassegrain telescope, has a central obscuration which may result in a reduction in image quality. In this regard, image quality increases, for example, when there are fewer aberrations and low blurring, which are effects that may result from optical system 55. Additional benefits of an all-reflective system may, in some examples, include unlimited spectral range, reduced absorption, and reduced thermal sensitivity. Furthermore, unlike conventional aspheric or conic mirrors, many or all freeform mirrors used in the optical system are not symmetric about any single axis and have a surface shape that is irregular and that is a function of at least two variables. When used in off-axis systems such as optical system 55, freeform mirrors enable enhanced aberration control, as explained previously.

In this regard, as the FOV of the optical system increases, the aberrations produced by that system may also increase. Examples of wide FOVs that may cause these effects include, but are not limited to, FOVs that are, 50° or greater, 60° or greater, 70° or greater, 80° or greater, 90° or greater, 100° or greater, 110° or greater, or 120° or greater. Freeform mirrors in the optical systems described herein may address—for example, correct—those aberrations. Distortion is an example of an aberration that may be corrected, at least in part, by optical system 55. In this regard, even when all other aberrations have been corrected or addressed, light from points on an object such as the Earth may converge on an image plane at the wrong distance from the optical axis, instead of being linearly proportional to the distance from the optical axis in the object. Barrel distortion 21 shown in FIG. 2 is an example of the type of distortion that may be corrected, at least in part, by optical system 55. Other types of distortion may also be corrected using optical system 55 by designing and/or configuring the freeform mirrors. Designing the freeform mirrors may include optimizing Zernike coefficients and other surface terms to produce a desired shape of the surface of each mirror. Configuring may include selecting an appropriate number of mirrors—four are shown in FIGS. 8 and 9; however, fewer or greater numbers or mirrors may be used—and arranging the mirrors relative to each other in the optical system.

Through appropriate design and configuration of freeform mirrors in an optical system, other types of aberrations may also be addressed including, but not limited to, those noted below. Generally, the greater the number of Zernike terms there are in the Zernike polynomial—for example, the higher the order of the Zernike polynomial—the more aberrations that may be addressed by the resulting mirror surface shape(s). The number of aberrations grows with the optical system's FOV. That is, wider FOVs may cause more aberrations. In an example, to correct N (where N is an integer greater than one) aberrations may require and optical system having approximately N variables. The greater number of variables and flexibility in controlling the optical surfaces using freeform mirrors increases the number of aberrations that can be corrected.

Example low order image aberrations that may be corrected in some cases include the five primary aberrations: spherical aberration, astigmatism, coma, field curvature, and distortion. In spherical aberration, the focal length depends on the pupil/aperture size. Astigmatism is caused when rays from an off-axis object enter the optical system asymmetrically and the focal length in one axis is different than the focal length in a perpendicular axis. Coma is caused when the magnification is a function of pupil/aperture position and field angle. Distortion is caused when the magnification is only a function of field angle and not pupil/aperture position. Field curvature, also called a Petzval field curvature, is caused when the focal length is a function of field angle resulting in a focal plane that is actually not planar, but spherical.

The example optical system 55 of FIGS. 8 and 9 may have a ratio of the system's focal length to a diameter of the entrance pupil of f/2.5, a 70° full FOV, a 2.5 inch effective focal length (EFL), and a +13% positive distortion to counter the negative distortion of the curved Earth from a polar orbit. FIG. 7 implies that a sensor in polar-orbit having a full field of view of 70° has an ideal distortion of +13% using the rectilinear EFL=x/tan(θ) definition. In optical system 55, mirrors 60, 63, 66, and 67 are all freeform mirrors, the Petzval sum is nearly zero, the aperture stop 69 is the exit pupil, and the first mirror is negative (convex) and has a large pupil magnification. These are all conditions for a wide FOV system—for example a system having a FOV of 70° or greater—having distortion control. Use of freeform mirrors may reduce distortion and increase image quality and enable greater FOV in this example system.

Example design parameters for optical system 55 are summarized in the table below. Mirror 60 is the largest of the mirrors at about 27 inches (68.6 centimeters) in height. The pupil magnification is 2.8 which reduces the FOV in image space, thereby reducing aberrations and increasing relative illumination. The on-axis pupil is 90% circular but becomes elliptical near the edge of field due to pupil coma. Although this example design has a relatively smaller entrance pupil diameter (EPD) relative the size of mirror 60, the design has a high optical throughput (AC) product). The large FOV and along-track (push-broom) imaging sensor configuration may allow for longer integration time that compensates for its relatively smaller entry pupil diameter (EPD).

| FOV (full) | 70 × 4 | deg |
|---|---|---|
| EPD | 1 | inch |
| f/# | 2.5 | |
| FPA size | 4 × 0.2 | inch |
| Mirror powers | N, 0, N, P | |
| Wavefront field avg (RMS @ 1 um) | 0.07 | waves |
| Primary mirror height | 27 | inch |
| Secondary mirror height | 13 | inch |
| Pupil mag (XP/EP) | 2.8 | |
| Pupil circularity, on-axis | 90.8% | |
| Smile angle, output | 0.6 | deg |

| | |
|---|---|
| Max distortion | 13% |
| Max Zernike term used | 26 |

The optical systems described herein are not limited to the design parameters shown in the preceding table. Rather, any appropriate design parameters may be used. For example, in some implementations, the EPD may be 0.4 inches or less.

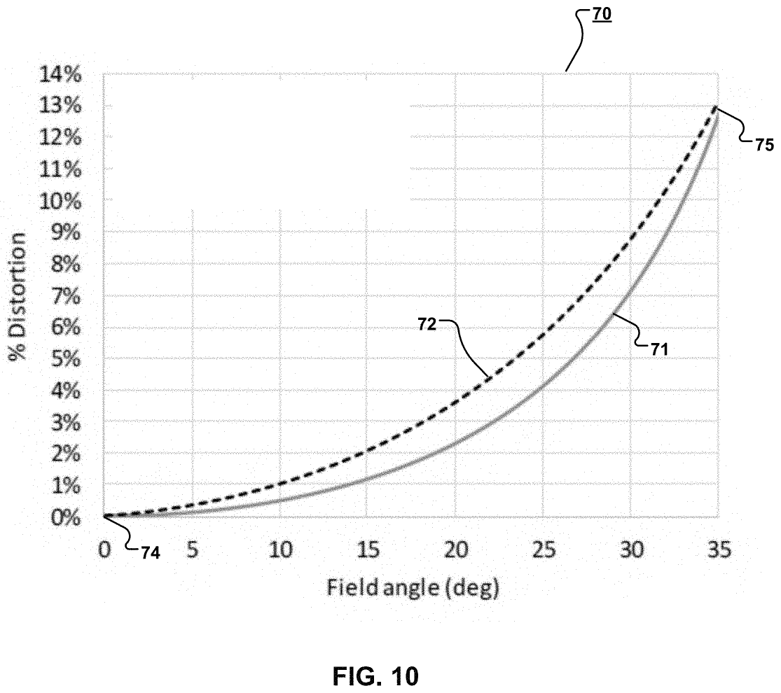

Referring to FIG. 10, graph 70 shows the actual positive distortion 71 (in percentage, %) produced by optical system 55 along the field angle (in degrees) compared to the ideal distortion 72 for a constant GSD for a satellite in in polar orbit. In this example, at edges 74, 75 of the field, the distortion 71 produced by optical system 55 matches ideal distortion 72. Distortion 71 is slightly less than ideal distortion 72 throughout the interior of the field. This residual error may result in non-linear, slight variations of GSD relative to FOV. There may be some residual GSD variation due to the finite number of control points used to constrain distortion.

In some implementations, optical system 55 may have a configuration different than that shown. For example, there may be fewer mirrors or a greater number of mirrors. The mirrors may be defined by different numbers of Zernike polynomials than those presented herein. One or more of the mirrors in system 55 may be non-freeform, for example rotationally-symmetric and axially-symmetric.

The preceding text describes examples of optical systems for optically introducing positive distortion into an image to counteract all or some of the negative distortion caused by the curvature of the Earth's surface. The optical systems described herein, however, are not limited to performing orthorectification during satellite imaging of the Earth's surface. Rather, the optical systems and processes described herein may be used to perform orthorectification during imaging on any type of spheroid, spherical object, or three-dimensional (3D) object having one or more surfaces that are curved. In other words, the example optical systems and processes described herein may optically introduce positive distortion into an image to counteract the negative distortion caused by the curvature of any 3D object's surface during imaging of that object.

Satellite and image sensor operation may be computer controlled. In addition, design and configuration of the freeform mirrors may also be computer controlled or implemented. For example, software may be executed to simulate freeform mirrors to produce a desired performance using appropriate Zernike polynomials.

Accordingly, at least part of the optical systems and processes described in this specification and their various modifications may be designed or configured at least in part by a system that includes one or more computers executing one or more computer programs tangibly embodied in one or more information carriers, such as in one or more non-transitory machine-readable storage media. A computer program can be written in any form of programming language, including compiled or interpreted languages, and it can be deployed in any form, including as a stand-alone program or as a module, part, subroutine, or other unit suitable for use in a computing environment. A computer program can be deployed to be executed on one computer or on multiple computers at one site or distributed across multiple sites and interconnected by a network.

Actions associated with designing or configuring the optical systems and processes can be performed by one or more programmable processors executing one or more computer programs to control all or some of the well formation operations described previously. All or part of the systems and processes can be configured or controlled by special purpose logic circuitry, such as, an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, such as magnetic, magneto-optical disks, or optical disks. Non-transitory machine-readable storage media suitable for embodying computer program instructions and data include all forms of non-volatile storage area, including by way of example, semiconductor storage area devices, such as EPROM (erasable programmable read-only memory), EEPROM (electrically erasable programmable read-only memory), and flash storage area devices; magnetic disks, such as internal hard disks or removable disks; magneto-optical disks; and CD-ROM (compact disc read-only memory) and DVD-ROM (digital versatile disc read-only memory).

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

Other implementations not specifically described in this specification are also within the scope of the following claims.

What is claimed is:

1. An optical system comprising:
freeform mirrors configured to receive light from an object and to reflect the light among the freeform mirrors to produce an optical image of the object having positive distortion, the freeform mirrors comprising non-rotationally symmetric mirrors; and
an along-track scanner comprising a line of imaging sensors configured to receive the optical image of the object from the freeform mirrors to produce an image of the object having the positive distortion.

2. The optical system of claim 1, wherein the freeform mirrors are each defined by a Zernike polynomial, the Zernike polynomial comprising Zernike coefficients that are based on the positive distortion and image quality to be produced by the freeform mirrors.

3. The optical system of claim 1, wherein the optical system is all-reflective and has a wide field-of-view, and wherein the freeform mirrors are off-axis and do not include a central obscuration.

4. The optical system of claim 1, wherein the freeform mirrors are each defined by a Zernike polynomial having 23 or more terms, each term being associated with a Zernike coefficient.

5. The optical system of claim 1, wherein the object is a spheroid and the positive distortion counteracts negative distortion resulting from a shape of the spheroid.

6. The optical system of claim 1, wherein the freeform mirrors comprise:
a first freeform mirror to receive light from the object and to reflect the light to produce first reflected light;
a second freeform mirror to receive and to reflect the first reflected light to produce second reflected light;
a third freeform mirror to receive and to reflect the second reflected light to produce third reflected light; and
a fourth freeform mirror to receive and to reflect the third reflected light to produce the optical image.

7. The optical system of claim 6, wherein:
the first freeform mirror comprises a negative optical-power surface;
the second freeform mirror comprises a zero optical-power surface;
the third freeform mirror comprises a negative optical-power surface; and
the fourth freeform mirror comprises a positive optical-power surface.

8. The optical system of claim 6, further comprising:
an aperture stop between the fourth freeform mirror and the along-track scanner, the aperture stop functioning as an exit pupil for reflections of the third reflected light produced by the fourth freeform mirror.

9. The optical system of claim 1, wherein the optical system has a field-of-view of 70° or more, and wherein the freeform mirrors are designed to reduce image aberrations at the field-of-view.

10. The optical system of claim 9, wherein the image aberrations comprise positive image distortion.

11. The optical system of claim 1, wherein the object is the Earth and the positive distortion to be produced by the freeform mirrors is based, at least in part, on an altitude of the along-track scanner relative to the Earth, a radius of the Earth, and a field angle of an imaging sensor in the along-track scanner.

12. A method comprising:
determining an amount of positive distortion to be produced by freeform mirrors based on a position of the freeform mirrors relative to an object, the freeform mirrors comprising non-rotationally symmetric mirrors;
configuring the freeform mirrors based on the amount of positive distortion;
receiving light from the object at the freeform mirrors;
reflecting the light among the freeform mirrors to produce an optical image of the object having the positive distortion; and
receiving the optical image of object from the freeform mirrors at an along-track scanner comprising imaging sensors, the imaging sensors obtaining an image of the object having the positive distortion based on the optical image.

13. The method of claim 12, wherein the freeform mirrors are each defined by a Zernike polynomial that is based on the positive distortion, the Zernike polynomial comprising Zernike coefficients that are based on the positive distortion.

14. The method of claim 12, wherein the freeform mirrors are each defined by a Zernike polynomial that is based on the positive distortion, the Zernike polynomial having 23 or more terms, each term being associated with a Zernike coefficient.

15. The method of claim 12, wherein the object is a spheroid and the positive distortion counteracts negative distortion resulting from a shape of the spheroid.

16. The method of claim 12, wherein receiving and reflecting comprises:
a first freeform mirror receiving light from the object and reflecting the light to produce first reflected light;
a second freeform mirror receiving and reflecting the first reflected light to produce second reflected light;
a third freeform mirror receiving and reflecting the second reflected light to produce third reflected light; and
a fourth freeform mirror receiving and reflecting the third reflected light to produce the optical image.

17. The method of claim 16, wherein:
the first freeform mirror comprises a negative optical-power surface;
the second freeform mirror comprises a zero optical-power surface;
the third freeform mirror comprises a negative optical-power surface; and
the fourth freeform mirror comprises a positive optical-power surface.

18. The method of claim 16, further comprising:
passing the third reflected light through an aperture stop between the fourth freeform mirror and the along-track scanner to produce the optical image.

19. The method of claim 12, wherein an optical system comprised of the along-track scanner and the freeform mirrors has a field-of-view of 70° or more, and wherein the freeform mirrors are designed to reduce image aberrations at the field-of-view.

20. The method of claim 19, wherein the image aberrations comprise image distortion.

21. The method of claim 12, wherein the object is the Earth and the positive distortion is determined based, at least in part, on an altitude of the along-track scanner relative to the Earth, a radius of the Earth, and a field angle of an imaging sensor in the along-track scanner.
